(19) United States
(12) Patent Application Publication
(10) Pub. No.: US 2026/0150953 A1
(43) Pub. Date: Jun. 4, 2026

(54) ROTARY CLIP FOR ATTACHING TOOLS AND POUCHES TO TOOLBOXES AND TOOLBELTS

(71) Applicants: Michael H. Panosian, Irvine, CA (US); Joshua M. Keeler, Irvine, CA (US)

(72) Inventors: Michael H. Panosian, Irvine, CA (US); Joshua M. Keeler, Irvine, CA (US)

(21) Appl. No.: 19/399,529

(22) Filed: Nov. 24, 2025

(30) Foreign Application Priority Data
Nov. 26, 2024 (CN) CN223232322U

(51) Int. Cl. A45F 5/02; A45F 5/00; B25H 3/02

(52) U.S. Cl. CPC A45F 5/021; A45F 5/1575; A45F 2005/026; B25H 3/02

(57) ABSTRACT

A device is disclosed including a rotary clip that is attached to a support structure, such as a toolbox or a wall, the rotary clip having a clip hook that is used to hang various objects, such as a pouch. The attached pouch follows the behavior of the clip hook. The rotary clip has two states including a locked state or mode and an unlocked or open mode of operation. The rotary clip is placed in one of the two modes of operation using a lock button. In locked mode, the rotary clip is locked in one of several lock positions. and may be forced out of the locked mode by sufficient force without damaging the rotary clip. In unlocked mode, the clip hook can turn 360 degrees.

The rotary clip further includes a spring washer, a ramp plate, a clutch plate, and a hook plate.

### TECHNICAL FIELD

This application relates generally to hanging apparatus. More specifically, this application relates to a rotary clip that is useable to attach tools and pouches to a toolbox or a toolbelt.

### BRIEF DESCRIPTION OF THE DRAWINGS

The drawings, when considered in connection with the following description, are presented for the purpose of facilitating an understanding of the subject matter sought to be protected.

FIG. 1 shows an example toolbox with an attached rotary clip;

FIG. 2A shows an exploded front view of the example rotary clip of FIG. 1;

FIG. 2B shows an exploded rear view of the example rotary clip of FIG. 1;

FIG. 3A shows an example front view of a clutch disk of the rotary clip of FIG. 1;

FIG. 3B shows an example rear view of the clutch disk of the rotary clip of FIG. 1;

FIG. 3C shows an example front view of a ramp disk of the rotary clip of FIG. 1;

FIG. 3D shows an example rear view of a ramp disk of the rotary clip of FIG. 1;

FIG. 4A shows an example clutch disk operation of the rotary clip of FIG. 1 in rotate mode;

FIG. 4B shows an example clutch disk operation of the rotary clip of FIG. 1 in lock mode;

FIG. 5A shows an example lock mode interaction of the clutch disk and ramp disk of the rotary clip of FIG. 1;

FIG. 5B shows an example rotate mode interaction of the clutch disk and ramp disk of the rotary clip of FIG. 1;

FIG. 5C shows an example lock mode force rotation interaction of the clutch disk and ramp disk of the rotary clip of FIG. 1;

FIG. 6A shows an example rotate mode of the rotary clip of FIG. 1;

FIG. 6B shows an example rotate mode cross-section A-A of the rotary clip of FIG. 1;

FIG. 7A shows an example lock mode of the rotary clip of FIG. 1;

FIG. 7B shows an example lock mode cross-section B-B of the rotary clip of FIG. 1;

FIG. 8A shows an example lock mode of the rotary clip of FIG. 1;

FIG. 8B shows an example lock mode forced rotation cross-section C-C of the rotary clip of FIG. 1;

FIG. 9A shows a first example configuration of the front side of the hook plate of the rotary clip of FIG. 1;

FIG. 9B shows a second example configuration of the front side of the hook plate of the rotary clip of FIG. 1;

FIG. 9C shows a third example configuration of the front side of the hook plate of the rotary clip of FIG. 1;

FIG. 9D shows a fourth example configuration of the front side of the hook plate of the rotary clip of FIG. 1;

FIG. 9E shows a fifth example configuration of the front side of the hook plate of the rotary clip of FIG. 1;

FIG. 9F shows a sixth example configuration of the front side of the hook plate of the rotary clip of FIG. 1;

FIG. 10A shows an example front view of a pouch and clip assembly;

FIG. 10B shows an example rear view of the pouch and clip assembly of FIG. 10A;

FIG. 11A shows an example exploded front view of a pouch clip adapter;

FIG. 11B shows an example exploded rear view of a pouch clip adapter; and

FIG. 11C shows an example a pouch clip adapter coupled with a rotary clip.

### DETAILED DESCRIPTION

While the present disclosure is described with reference to several illustrative embodiments and example devices described herein, it should be clear that the present disclosure should not be limited to such embodiments. Therefore, the description of the embodiments provided herein is illustrative of the present disclosure and should not limit the scope of the disclosure as claimed. In addition, while the following description references toolboxes and pouches that are used with the rotary clip, it will be appreciated that the disclosure may be applicable with other types of environments like inside of work trucks and other equipment and accessories that hang from the rotary clip.

Briefly described, a system and a method are disclosed including a rotary clip that is attached to a support structure, such as a toolbox, toolbelt, or a wall, the rotary clip having a clip hook that is used to hang various objects, such as pouches and tools. The attached objects, such as the pouch, have a receptacle that is designed to fit and lock onto the clip hook. The coupled pouch will follow the behavior of the clip hook. The rotary clip has two states including a locked state or mode and an unlocked or open mode of operation. The rotary clip is placed in one of the two modes of operation using a lock button to switch between the two modes. In locked mode, the rotary clip is locked in one of several lock positions and may be forced out of the locked mode by excessive force, which overcomes the lock force but does not damage or destroy the rotary clip. In unlocked mode, the clip hook can freely turn 360 degrees around its pivot point.

The rotary clip further includes a spring washer, a ramp plate, a clutch plate, and a hook plate. In some embodiments the lock button and the ramp plate form a rack-and-pinion configuration for switching between the two modes of operation. In various embodiments, different accessories, tools, pouches and other items that may need a hanging apparatus may be equipped with a hook receptacle specifically for use with the clip hook on the rotary clip.

In various embodiments, a pouch is disclosed including a hook receptacle assembly to attach the pouch onto a mounting apparatus. A locking mechanism locks the pouch to prevent the pouch from rotating and unlocks the pouch to allow the pouch to rotate more than 30 degrees from a gravitational vertical orientation.

In various embodiments, a pouch and clip assembly is disclosed including a pouch, and a pouch adapter coupled with the pouch, the pouch adapter including a hook receptacle to mount onto a hook. The pouch is rotatable more than 30 degrees and is lockable in a lock position.

In various embodiments, a method of hanging objects is disclosed including receiving a clip hook of a rotary clip onto an object, locking the object in a predetermined lock position, and unlocking the object to rotate more than 30 degrees.

In technical work environments, such as workshops, garages, manufacturing sites, building sites, and the like, toolboxes and various hand tools, pouches, and light power tools like drills and saws are often used. For efficiency and convenience, the tools and pouches containing various parts like nails and nuts need to be available in a quick and convenient but secure manner. Various types of hooks, such as S-hooks, peg boards, and nails in walls or boards, are often used for this purpose. However, these hanging apparatuses are often non-standard and unreliable and are not suitable for many types of tools due to size, weight and shape of the tools. Hence, a more standardized, strong, portable, and convenient hanging apparatus is desirable.

It is to be noted that directions, orientations, and other relative terms such as “front”, “back”, “top”, “bottom”, “left”, “right”, “inside”, “outside”, “interior”, “exterior”, “downward”, “upward”, “front-facing”, “down-facing”, “vertical”, “horizontal”, “diagonal”, and the like are described with respect or relative to a distinguishing feature of the system or device body itself. For example, if the front part or surface of a system body or an object is identified in the description, then rear or back is defined as the part or surface opposite the front surface, left is defined as the left side when looking into the front surface, and so on. As long as directions are unambiguously identifiable based on the descriptions and figures, how the orientations are defined is immaterial.

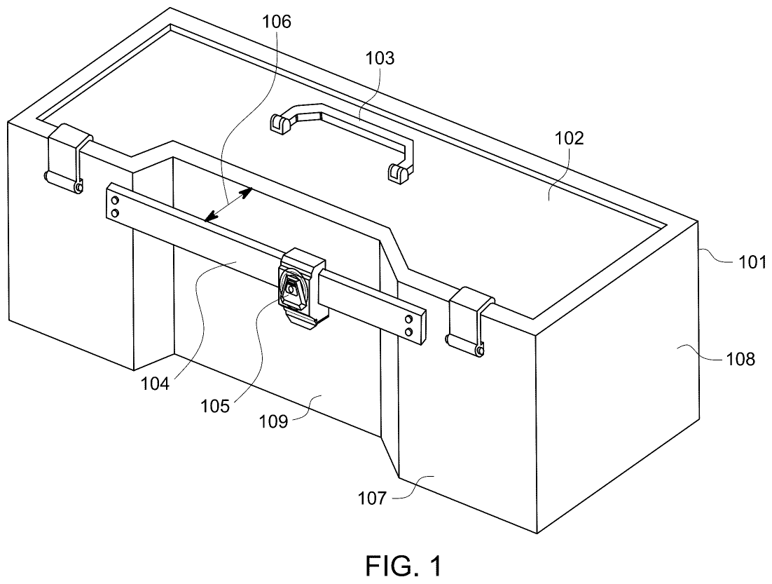

FIG. 1 shows an example toolbox with an attached rotary clip. More specifically, FIG. 1 shows a container 101 having a lid 102, handle 103 and clip bar 104 to hang rotary clip 105, mounting gap 106, front sidewall 107, right sidewall 108, and recessed sidewall 109.

In various embodiments, container 101 may be a storage container, a toolbox, a cabinet, or other similar enclosure that has sidewalls useable to hang various objects, such as tools like drills, wrenches, and other objects such as pouches and small containers.

In various embodiments, clip bar 104 may be attached to a support or mounting structure or surface, such as a container 101 front sidewall 107 or right sidewall 108. A recessed sidewall 109 may be employed to create the mounting gap 106 to provide clearance for the rotary clip 105 attachment to the clip bar 104, which is enclosed by the rotary clip 105. The mounting surface may be the side of a container, such as a toolbox, a cabinet sidewall, a wall, or the side of any structure in a way that provides sufficient clearance to mount the rotary clip 105. Clip bar 104 may be attached to a support or mounting surface, such as the side of a toolbox or a wall, and generally provides a clip bar gap or clearance to accommodate the rotary clip 105 being mounted on the clip bar 104 and enclosing the clip bar 104, as shown in FIG. 1. For example, the container 101 shown in this figure, has a front sidewall 107 and a recessed sidewall 109, which together create the gap 106 behind the clip bar 104, as shown.

In various embodiments, rotary clip 105 may be attached to toolbox 101 via clip bar 104. Rotary clip 105 may also be attached to or mounted on any other type of support element or member such as a toolbelt, a rope, a wire, or any other support member that can pass through the rotary clip 105 passageway or slit (shown in later figures) in the rotary clip 105.

In various embodiments, different accessories, tools, pouches and other items that may need a hanging apparatus may be equipped with a hook receptacle specifically designed for use with the clip hook on the rotary clip 105. The hook receptacles hold the accessory or tool securely fastened to the rotary clip 105 and does not easily come off or fall off the rotary clip 105. For example, a worker wearing a toolbelt, with one or more rotary clips attached to various tools and accessories, may crouch under a table, climb a ladder, walk, jump, or run, while keeping all the accessories and pouches securely held on the toolbelt.

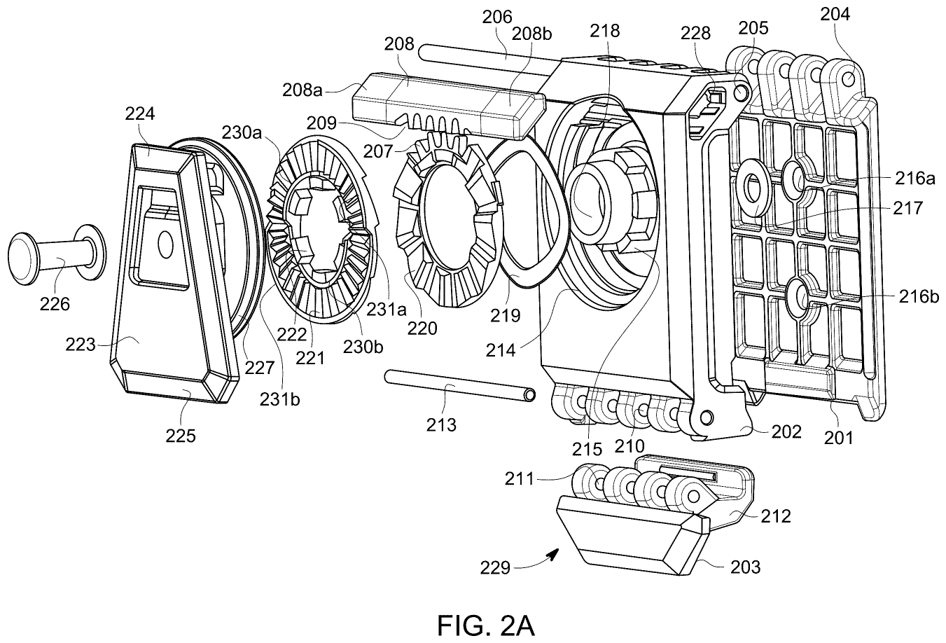

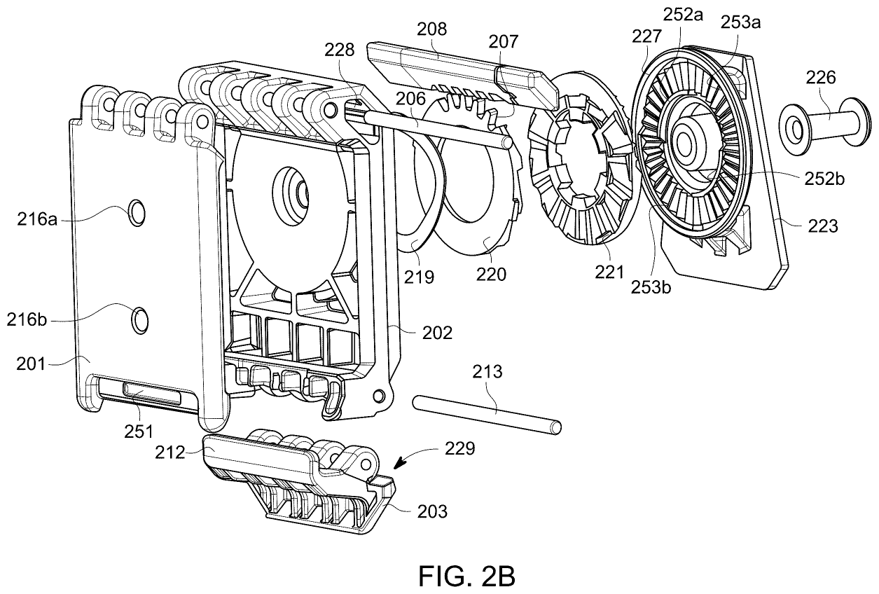

FIG. 2A shows an exploded front view of the example rotary clip of FIG. 1. More specifically, FIG. 2A shows a front view of the rotary clip 105 having a clip rear plate or shell 201, a clip front shell 202, a latch finger grip 203, a rear shell hinge 204, a front shell top hinge 205, a top hinge rod 206, a ramp plate pinion 207, a clip lock button 208, a first button end 208a, second button end 208b, a lock button rack 209, a front shell bottom hinge 210, a shell latch hinge 211, a shell latch hook 212, a front shell bottom hinge rod 213, a ring or plate housing 214, hub teeth 215, a rear shell holes 216a and 216b, a rivet washer 217, a hub 218, spring washer 219, a cam or ramp ring or plate 220, a clutch plate 221, clutch plate teeth 222, a clip hook 223, a hook narrow end 224, a hook broad end 225, a clip rivet 226, a hook plate 227, a lock button channel 228, a shell latch 229, clutch partial inner rims 230a and 230b, and clutch partial outer rims 231a and 231b.

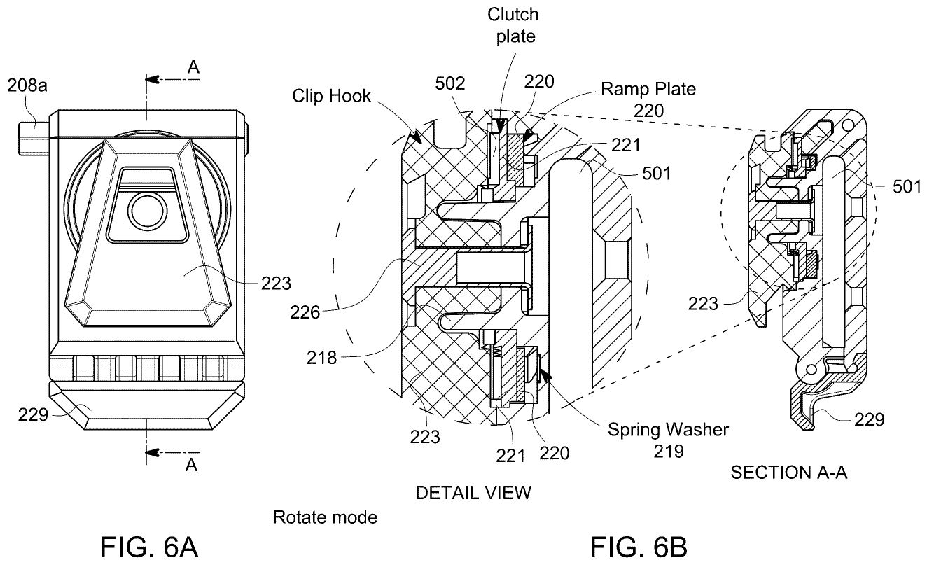

In various embodiments, rotary clip 105 may take the general form of a clam shell with two half shells that are hinged at one end and can be opened or closed on the other end. A gap, a passageway, or a slit may be formed between the two half shells to allow the passage of rigid bar, a flexible belt, a cable or rope, or other members that are suitable to mount the rotary clip 105 on. In some embodiments the passageway (see FIG. 6B) between the two half shells encloses the clip mounting member, such as the clip bar 104, is fully enclosed by the passageway. In other various embodiments, rotary clip 105 may be in the form of a one-piece housing with an additional belt hook for mounting the rotary clip on a belt or other clip mounting member.

In various embodiments, the two half shells include the rear shell 201 and the front shell 202, which may be coupled together permanently (not user-configurable) at the top via the rear shell hinge 204 and the front shell top hinge 205 and top hinge rod 206. Unless explicitly stated otherwise, for direction and orientation purposes, the location of the rear shell hinge 204 will be considered as the top of the rotary clip 5. Rear shell 201 and front shell 202 may further be attached and/or locked together at the bottom of the rotary clip 5 using the shell latch 229. Latch hook 212 may be used to lock rear shell 201 and front shell 202 together by grabbing a recess in the back of rear shell 201. Latch finger grip 203 may be used to unhook latch hook 212 from rear shell 201 to open the clam shell formed by rear shell 201 and front shell 202. This way the passageway created between rear shell 201 and front shell 202 is opened to mount rotary clip 105 on a clip mounting member, such as clip bar 104 or a toolbelt.

In various embodiments, front shell 202 may have a built-in ring, disk, or plate housing 214 that encloses and contains other various ring-shaped disks or plates or components including spring washer 219, ramp plate 220, clutch plate 221, and hook plate 227. These components may be held together with a rivet 226, or an equivalent fastener such as a bolt and a nut, that passes through clip hook 223, hook plate 227, clutch plate 221, cam or ramp plate 220, spring washer 219, hub 218 front shell 202, and washer 217, as depicted in the exploded view shown in FIGS. 2A and 2B. The plate housing 214 may further include some hub teeth 215 used to restrict the rotational motion of clutch plate 221 by meshing with or engaging the corresponding or matching clutch plate teeth 222. This way, clutch plate 221 can only move inwards and outwards with respect to the plane of the front shell 202 and plate housing 214.

In various embodiments, rear shell holes 216a and 216b may be used to mount rotary clip 105 from a vertical surface, such as a wall, a pegboard, the side of a cabinet, and the like, using studs or protrusions that pass through the rear shell holes 216a and 216b.

In various embodiments, spring washer 219 may have a wavy form that creates a three-dimensional (3D) shape as shown. The spring washer 219 has two functions: one function is to act as a spacer and raise or push the ramp plate farther away from a bottom of the plate housing 214 (bottom and top here mean when the rotary clip 105 is held to make the front shell 202 parallel to ground and the bottom of the plate housing 214 is also in a horizontal orientation), and the second function is to force ramp plate 220 and clutch plate 221 to be engaged together for the operation of the rotary clip 105. The spacer function of spring washer 219 raises ramp plate 220 above the bottom of the hub teeth 215 so that the ramps on the ramp plate 220 can reach and affect the in and out position of the clutch plate.

In various embodiments, cam or ramp plate 220 has an asymmetrical sawtooth ramp front surface and a smooth back surface, as described in more detail with respect to other figures. Top of the perimeter of the ramp plate 220 includes teeth on the ramp plate pinion 207 that engage the teeth on the lock button rack 209, together forming a rack-and-pinion arrangement for locking and unlocking the clip hook 223 for rotational operation. The smooth back surface of the ramp plate 220 faces towards and engages with spring washer 219. The sawtooth ramp front surface faces and engages with the back surface of the clutch plate 221, which has similar matching sawtooth ramps, as further described below. The asymmetrical sawtooth ramps on the front surface of the ramp plate 220 are all oriented in the same direction with each ramp rising to a maximum height and then sharply falling at 90-degree angles to a minimum height with respect to the ramp plate 220, as described further with respect to other figures.

In various embodiments, clutch plate 221 has two surfaces including a symmetrical sawtooth front surface facing the symmetrical sawtooth surface of hook plate 227, and an asymmetrical sawtooth ramp rear surface facing the asymmetrical sawtooth ramp front surface of the ramp plate 220. Clutch plate 221 may be used to engage hook plate 227 to lock it and prevent clip hook 223 from rotation, or to disengage hook plate 227 to allow it to rotate freely 360 degrees. Clutch plate 221 has clutch partial inner rims 230a and 230b, and clutch partial outer rims 231a and 231b. These rims engage corresponding partial inner rims 252a and 252b, and clutch partial outer rims 253a and 253b on the hook plate 227. When these rims on the clutch plate 221 and hook plate 227 are in direct contact, the symmetrical sawtooth elements on both plates are distanced from each other, precluding the locking of the hook plate 227.

In various embodiments, hook plate 227 is integrated with clip hook 223 as one piece. Hook plate 227 may be locked in place by clutch plate 221, thereby locking the clip hook 223 and preventing it from rotation. This operation is further described below.

In various embodiments, clip lock button 208 has first button end 208a and second button end 208b. One of the ends of the clip lock button 208, for example, the first button end 208a, may be painted to a different color than the clip front shell 202 to provide better visibility and easy detection of the state of the rotary clip 105. The rotary clip 105 has two operational states or modes: a locked state or more and an open (unlocked) state or mode. In the locked state, the clip hook 223 (and the integrated hook plate 227) is locked in a definite predetermined orientation around the perimeter of the plate housing 214. In the open state, the clip hook 223 is allowed to rotate 360 degrees around the perimeter of the plate housing 214. The rotary clip 105 is in locked state when the second button end 208b (uncolored end) is fully visible and is fully outside the lock button channel 228, while the first button end 208b (colored end) is not fully visible and is mostly (other than its cross-section) hidden inside the lock button channel 228, as further shown and described with respect to other figures. The teeth on the lock button rack 209 is always engaged with the teeth of the ramp plate pinion 207, regardless of the state of the rotary clip 105.

In various embodiments, the clip rivet 226 forms an axel or a pivot point around which the clip hook 223 may rotate 360 degrees in both clockwise and counterclockwise directions, when the rotary clip 105 is in the unlocked or open mode.

In various embodiments, rotary clip 105 is considered a mounting apparatus, device, or point for mounting or attaching various items and objects, such as tools, pouches, devices, and the like, that may be suitably mounted on a surface or toolbelt for easy access, storage, carrying and transportation. Some of the items that are mounted on the mounting apparatus (for example, the rotary clip 105), such as a pouch, may include their own locking and control mechanisms to control their movement, orientation, positioning, locking, releasing, and the like. For example, a pouch may include its own locking mechanism deployed within the pouch that locks the pouch in position on the mounting apparatus and does not depend on any locking or release mechanism deployed on the mounting apparatus.

FIG. 2B shows an exploded rear view of the example rotary clip of FIG. 1. More specifically, FIG. 2B shows the view of rotary clip 105 from a rear perspective. It shows clip rear shell 201, clip front shell 202, latch finger grip 203, top hinge rod 206, ramp plate pinion 207, clip lock button 208, a shell latch hinge 211, shell latch hook 212, front shell bottom hinge rod 213, rear shell holes 216a and 216b, hub 218, spring washer 219, ramp plate 220, clutch plate 221, clip hook 223, clip rivet 226, hook plate 227, lock button channel 228, shell latch 229, rear shell recess 251, hook plate partial inner rims 252a and 252b, and hook plate partial outer rims 253a and 253b.

In various embodiments, the hook plate 227 has a symmetrical sawtooth front surface that engages the front surface of the clutch plate 221. Hook plate 227 further includes the hook plate partial inner rims 252a and 252b, and hook plate partial outer rims 253a and 253b that match the corresponding rims on the clutch plate 221, namely, clutch partial inner rims 230a and 230b, and clutch partial outer rims 231a and 231b. The partial rims on the hook plate 227 and clutch plate 221 are above their respective symmetrical sawtooth surfaces in relation to the respective plates. This way, when the partial rims in each plate is in contact with the corresponding partial rims of the other plate, the symmetrical sawtooth surfaces do not engage because the partial rims prevent the surfaces from getting close enough to come into contact. In this configuration the rotary clip 105 is in an open (or unlocked) state and the clutch plate 221 cannot lock the hook plate 227 to prevent its rotation. Accordingly, when the partial rims on these plates are not in contact with each other, the symmetrical sawtooth surfaces can come in contact and clutch plate 221 can lock hook plate 227 (and clip hook 223). This configuration corresponds to the locked state of the rotary clip 105.

In various embodiments, the partial rims described above include two partial rims on each of the clutch plate 221 and hook plate 227. The two partial rims define two angular lock positions for the clip hook 223 (and hook plate 227). One lock position is defined by the hook narrow end 224 being on top (next to lock button 208), and the other lock position is defined by the hook broad end being on top. Any other angular position does not allow the locking of the clip hook 223, even if the lock button 208 is in the locked state.

In various embodiments, rear shell recess 251 is used to receive and secure shell latch hook 212 when the shell latch 229 is locked to keep the rear shell 201 and front shell 202 locked together.

In various embodiments, in operation, rotary clip 105 is attached to a support member, such as a toolbelt or clip bar 104, and the clip hook 223 is allowed to rotate when in open or unlocked state. When in locked state, clip hook 223 can be in one of several predetermined positions around the circular perimeter of the rotary clip 105. The locking of the clip hook 223 is performed by pushing clip lock button 208 to a predetermined side of the clip front shell 202, for example, the left side when facing the clip hook 223. Pushing the clip lock button 208 to the lock position when, the second button end 208b (uncolored end) is outside the clip front shell 202, causes the clutch plate 221 to be pushed towards the hook plate 227 and engage it, thereby locking it in place if the hook plate 227 is at a predetermined lock position. The locking mechanism and its actuation components for the locking and unlocking of the rotary clip 105 includes the lock button 208, the spring washer 219, ramp plate 220, clutch plate 221 and hook plate 227.

In various embodiments, to place the rotary clip 105 in locked state, the operator or user of the rotary clip 105 manually pushes the lock button in the predetermined direction of the lock state. This direction is signified by the uncolored button end 208b or 208a that is pushed out of the lock button channel 228 and becomes visible. With reference to FIGS. 2A and 2B, the lock direction is to the right of clip front shell 202 when look at the clip hook 223 (FIG. 2A). This motion of the lock button 208 causes the lock button rack 209 to rotate the ramp plate pinion 207 in clockwise (CW) direction, pushing the asymmetrical sawtooth ramps or elements on the ramp plate 220 to connect with and push the corresponding asymmetrical sawtooth ramps on the clutch plate 220 towards hook plate 227. This push, in turn, causes the symmetrical sawtooth elements on the clutch plate 221 to engage the corresponding symmetrical sawtooth elements on the hook plate 227, thereby placing the rotary clip 105 in a locked state.

In various embodiments, to place the rotary clip 105 in an unlocked or open state, the reverse of the operations described above for locking the rotary clip 105 are performed. More specifically, the lock button 208 is pushed to the left by the user causing the ramp plate pinion 207 to rotate counterclockwise (CCW), pushing the asymmetrical sawtooth ramps or elements on the ramp plate 220 to cease contact with and allow the corresponding asymmetrical sawtooth ramps on the clutch plate 220 to move away from hook plate 227. This, in turn, causes the symmetrical sawtooth elements on the clutch plate 221 to disengage from the corresponding symmetrical sawtooth elements on the hook plate 227, thereby placing the rotary clip 105 in an open or unlocked state.

In various embodiments, when the rotary clip 105 is in locked state, the clip hook 223 cannot be rotated under normal usage conditions, preventing it from freely swinging back and forth from the pivot point where rivet 226 is located. In the locked state, even moderate manual force, for example 3-10 foot-pounds (4.1-13.6 Newton-Meters) of torque, does not cause the locked clip hook 223 to rotate. As a personal safety and/or product damage prevention measure, larger amounts of force can force rotation of the clip hook 105. For example, if a worker is wearing a toolbelt with a pouch hanging from the clip hook 223 and he is walking fast past a workbench, and the pouch is caught on the corner of the workbench, the clip hook 223 can be forced to rotate instead of causing damage to the rotary clip 105 or possibly cause the worker to fall or get injured. This safety mechanism is implemented via the 3D spring washer 219 that is forced flat into a two-dimensional (2D) configuration, allowing the ramp plate 220 and clutch plate 221 to back off from contacting the hook plate 227 under force and, in turn, allowing rotation of the clip hook 223. This behavior is further described below with respect to other figures herein.

In various embodiments, when the rotary clip 105 is in an unlocked or open state, the clip hook 223 may freely rotate under small torque such as the weight of a tool or a pouch hanging from the clip hook 223. For example, if a worker wearing a toolbelt and using a rotary clip 105 with a pouch or a tool hanging from the clip hook 223 is climbing a ladder, the pouch is automatically placed in upright position due to the rotation of the clip hook 223 under the weight of the pouch. This way, the contents of the pouch, for example, nails, do not spill out because the pouch stays upright even though the worker is climbing a ladder at an angle with respect to gravitational horizon.

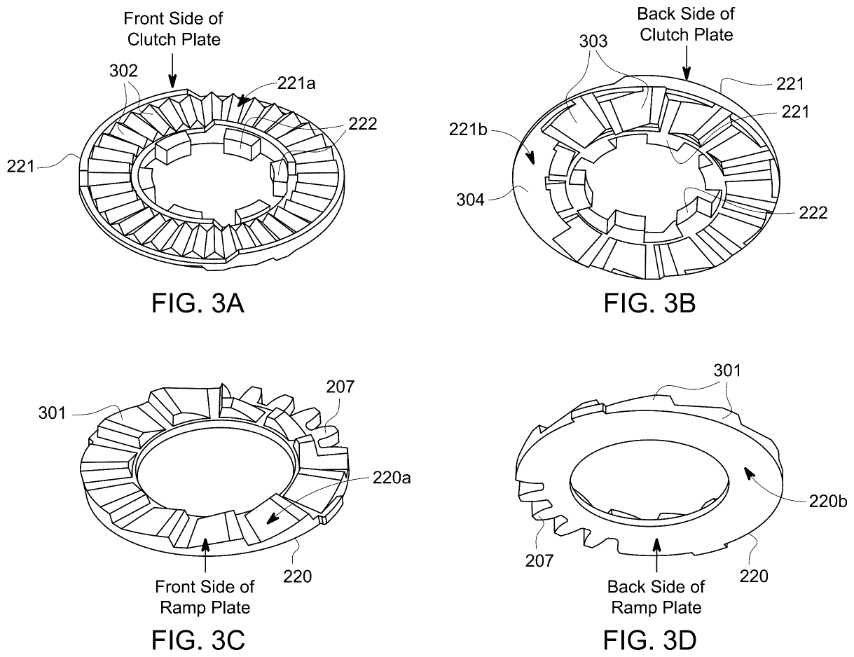

FIG. 3A shows an example front view of a clutch disk of the rotary clip of FIG. 1. More specifically, FIG. 3A shows clutch disk 221, clutch plate front surface 221a, clutch plate teeth 222, and clutch symmetrical sawtooth elements 302.

In various embodiments, the symmetrical sawtooth elements 302 are designed to match and engage corresponding symmetrical sawtooth elements of the hook plate 227. As described above with respect to FIGS. 2A and 2B, the symmetrical sawtooth elements are used to place the rotary clip 105 is locked mode.

FIG. 3B shows an example rear view of the clutch disk of the rotary clip of FIG. 1. More specifically, FIG. 3B shows a clutch plate rear surface 221b, clutch plate teeth 222, clutch asymmetrical sawtooth elements 303, and rear surface flat portion 304.

In various embodiments, the clutch asymmetrical sawtooth elements 303 are designed to engage with the asymmetrical sawtooth elements (see FIG. 3C) on the ramp plate 220 to push the ramp plate towards the hook plate 227 along the axis defined by the clip rivet 226, as further described below. The clutch plate teeth 222 engage with the corresponding hub teeth 215 to keep the clutch plate 221 from rotating. This way, the clutch plate 221 is limited to motion along the longitudinal axis of the rivet 226. The clutch asymmetrical sawtooth elements 303 act like ramps or cams that when moving cause a motion in the elements they come in contact with. The motion of the elements the ramps or cams come in contact with are usually a translational motion, such as up-and-down or in-and-out along a linear pathway to which they are constrained. FIG. 3C shows an example front view of a ramp disk of the rotary clip of FIG. 1. More specifically, FIG. 3C shows ramp plate 220, ramp plate front surface 220a, ramp asymmetrical sawtooth elements 301, and ramp plate pinion 207.

In various embodiments, the ramp asymmetrical sawtooth elements 301 are discreet ramps that start at a base position on the ramp plate 220 and increase in height at a predetermined slope or angle. When a ramp asymmetrical sawtooth element 301 comes in contact with a clutch asymmetrical sawtooth element 303 during the CW circular motion of the ramp asymmetrical sawtooth element 301 (caused by pushing the lock button 208 in the locking direction along the lock button channel 228), it acts as a cam or wedge that pushes the clutch asymmetrical sawtooth element 303 along the axis of the clip rivet 226 towards the hook plate 227. When the ramp plate 220 moves in the CCW direction (caused by pushing the lock button 208 in the unlocking direction along the lock button channel 228), the ramp asymmetrical element 301 backs off from the clutch asymmetrical elements 303, allowing the clutch plate 221 to move along the axis of the clip rivet 226 away from the hook plate 227.

In various embodiments, the ramp plate pinion 207 fits on the rear surface flat portion 304 of clutch rear surface 221b. This arrangement allows for the smooth rotation of the ramp plate 220 when it is moving CW or CCW in response to the sliding motion of the lock button 208 within the lock button channel 228.

FIG. 3D shows an example rear view of a ramp disk of the rotary clip of FIG. 1. More specifically, FIG. 3D shows a ramp plate rear surface 220b, ramp asymmetrical sawtooth elements 301, and ramp plate pinion 207.

In various embodiments, the ramp plate rear surface 220b is flat and smooth to allow easy and smooth rotation of ramp plate 220 in response to the sliding motion of the lock button 208 within the lock button channel 228.

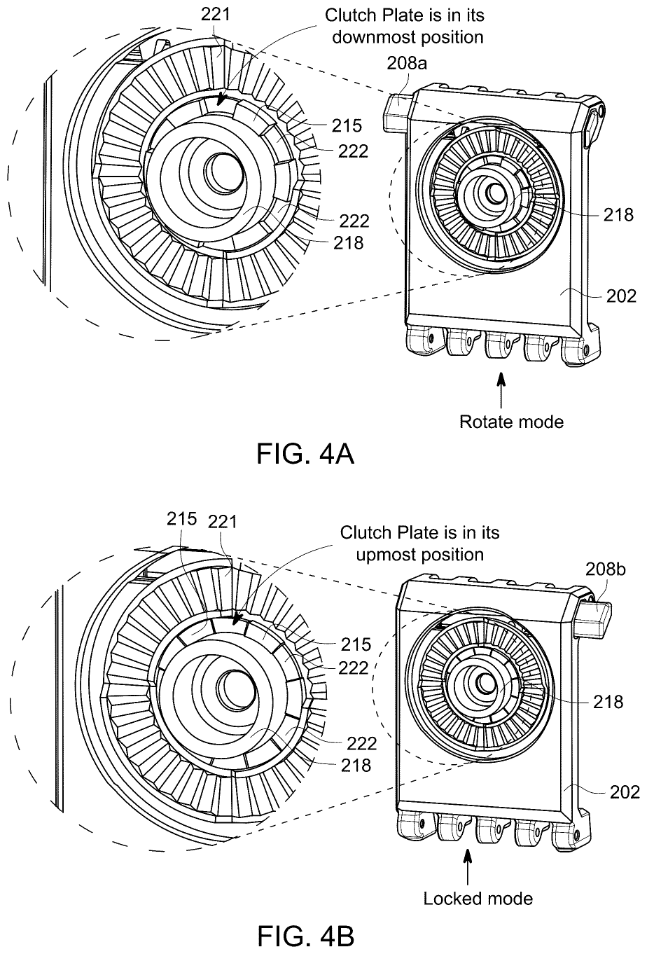

FIG. 4A shows an example clutch disk operation of the rotary clip of FIG. 1 in rotate mode. More specifically, FIG. 4A shows clip front shell 202, first button end 208a, clutch plate 221, hub 218, hub teeth 215, and clutch plate teeth 222.

In various embodiments, when the clip lock button is pushed to the left and the colored first button end 208a becomes visible, the rotary clip 105 is placed in unlocked mode and the clutch plate 221 is farthest away from the hook plate 227, allowing the clip hook 223 to rotate freely. In this configuration, the clutch plate teeth 222 is at a lower level (closest to the clip front shell 202) than the hub teeth 215. The relative positions of the clutch plate teeth 222 and the hub teeth 215 are shown in this figure. The top (free end of the teeth facing away from clip front shell 202) of the clutch plate teeth 222 are below the top of the hub teeth 215.

FIG. 4B shows an example clutch disk operation of the rotary clip of FIG. 1 in lock mode. More specifically, FIG. 4B shows clip front shell 202, second button end 208b, clutch plate 221, hub 218, hub teeth 215, and clutch plate teeth 222.

In various embodiments, when the clip lock button is pushed to the right and the uncolored second button end 208b becomes visible, the rotary clip 105 is placed in locked mode and the clutch plate 221 is closest to the hook plate 227, allowing the clip hook 223 to rotate freely. In this configuration, the clutch plate teeth 222 is at the same level as the hub teeth 215. The relative positions of the clutch plate teeth 222 and the hub teeth 215 are shown in this figure. The top of the clutch plate teeth 222 are at the same level as the top of the hub teeth 215.

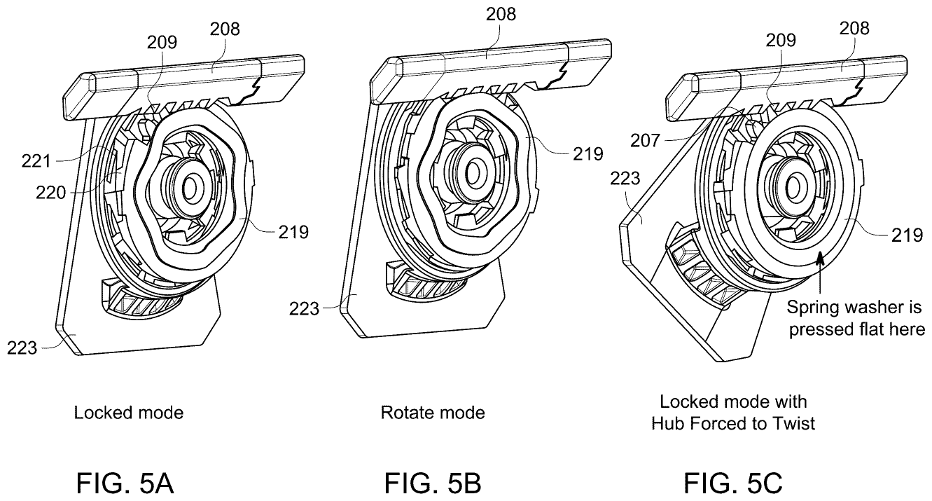

FIG. 5A shows an example lock mode interaction of the clutch disk and ramp disk of the rotary clip of FIG. 1. More specifically, FIG. 5A shows clip lock button 208, ramp plate pinion 207, lock button rack 209, clutch plate 221, ramp plate 220, spring washer 219, and clip hook 223.

In various embodiments, in locked mode, the clip lock button 208 is pushed right causing lock button rack 209 to force CW rotation of ramp plate pinion 207, which in turn causes the ramp plate 220 to be pushed towards the clutch plate 221 with the ramp asymmetrical sawtooth elements 301 engaged with the clutch asymmetrical sawtooth elements 303. In this configuration the highest points of the ramp elements (301 and 303) are in contact, causing the greatest gap between the ramp plate 220 and the clutch plate 221. This gap in turn causes the clutch plate 221 to be forced into the hook plate 227, thereby locking the clip hook 223.

FIG. 5B shows an example rotate mode interaction of the clutch disk and ramp disk of the rotary clip of FIG. 1. More specifically, FIG. 5B shows clip lock button 208, ramp plate pinion 207, lock button rack 209, clutch plate 221, ramp plate 220, spring washer 219, and clip hook 223.

In various embodiments, in locked mode, the clip lock button 208 is pushed left causing lock button rack 209 to force CCW rotation of ramp plate pinion 207, which in turn allows the ramp asymmetrical sawtooth elements 301 disengaged from the clutch asymmetrical sawtooth elements 303. In this configuration the highest points of the ramp elements (301 and 303) are not in contact, causing a zero gap (plates touching) between the ramp plate 220 and the clutch plate 221. This configuration of plates touching in turn causes the clutch plate 221 to be distanced from the hook plate 227, thereby unlocking the clip hook 223.

FIG. 5C shows an example lock mode force rotation interaction of the clutch disk and ramp disk of the rotary clip of FIG. 1. More specifically, FIG. 5C shows clip lock button 208, ramp plate pinion 207, lock button rack 209, clutch plate 221, ramp plate 220, spring washer 219, and clip hook 223.

In various embodiments, when the rotary clip 105 is in locked mode, the clip hook 223 does not rotate under moderate manual force. Under a larger than moderate force that is insufficient to destroy or damage the rotary clip 105 or any of its components, but is sufficient to overcome the locking force that is holding the clip hook 223 in a locked position, the clip hook 223 can rotate. Under this larger force, the rotary clip 105 can enter into an unlocked operation mode without the user changing the operation mode by using the clip lock button 208. In this situation, clip lock button 208 stays in the locked state and if the clip hook 223 is rotated to one of several lock positions, the rotary clip 105 returns to a locked mode without the user's action of using the clip lock button 208 to change the operation mode. In this scenario, the 3D spring washer 219 is pressed down to become a flat 2D disk, creating more space between the clutch plate 221 and hook plate 227 and allowing the clutch partial inner rims 230a and 230b and clutch partial outer rims 231a and 231b to come into contact and engage corresponding hook plate partial inner rims 252a and 252b, and hook plate partial outer rims 253a and 253b. At this point the clip hook 223 is rotated at an angle other than the predetermined lock angles of zero degrees (with hook narrow end 224 up) and 180 degrees (with hook broad end 225 up). In this configuration, the clip hook 223 may be rotated manually and when it reaches the predetermined lock angles, the clip hook 223 gets locked normally again. During this scenario, the lock button 208 remains in its original lock position.

FIG. 6A shows an example rotate mode of the rotary clip of FIG. 1. More specifically, FIG. 6A shows rotary clip 105 with clip hook 223, button first end 208a, and section A-A.

The lock button 208 is in its left-most position placing the rotary clip 105 in an unlocked mode. The cross-section A-A is described further below with respect to FIG. 6B.

FIG. 6B shows an example rotate mode cross-section A-A of the rotary clip of FIG. 1. More specifically, FIG. 6B shows a passageway 501 between the clip rear shell 201 and clip front shell 202, hub 218, ramp plate 220, clutch plate 221, clip rivet 226, clip hook 223, shell latch 229, air gap 502 between clutch plate 221 and hook plate 227 (integrated with clip hook 223).

In various embodiments, when the rotary clip 105 is in unlocked mode, as signified by the lock button 208 being in its left-most position and the first button end 208a being visible, the clutch partial inner rims 230a and 230b and clutch partial outer rims 231a and 231b come into contact with and engage corresponding hook plate partial inner rims 252a and 252b, and hook plate partial outer rims 253a and 253b. This arrangement creates the air gap 502 between these plates and allows the clip hook 223 to rotate freely.

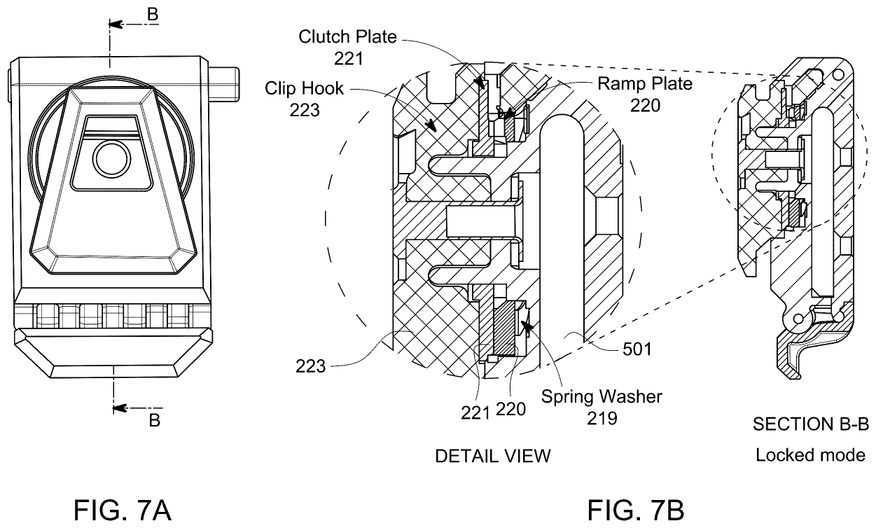

FIG. 7A shows an example lock mode of the rotary clip of FIG. 1. More specifically, FIG. 7A shows rotary clip 105 with clip hook 223, button second end 208b, and section A-A.

The lock button 208 is in its right-most position placing the rotary clip 105 in the locked mode. The cross-section B-B is described further below with respect to FIG. 7B.

FIG. 7B shows an example lock mode cross-section B-B of the rotary clip of FIG. 1. More specifically, FIG. 7B shows a passageway 501 between the clip rear shell 201 and clip front shell 202, hub 218, ramp plate 220, clutch plate 221, clip rivet 226, clip hook 223, and shell latch 229.

In various embodiments, when the rotary clip 105 is in locked mode, as signified by the lock button 208 being in its right-most position and the first button end 208b being visible, the clutch partial inner rims 230a and 230b and clutch partial outer rims 231a and 231b are not in contact with and are disengaged from the corresponding hook plate partial inner rims 252a and 252b, and hook plate partial outer rims 253a and 253b. This arrangement eliminates the air gap 502 between these plates and prevents the clip hook 223 from rotating freely because the clutch symmetrical sawtooth elements 302 come in contact with and engage the symmetrical sawtooth elements on the hook plate 227.

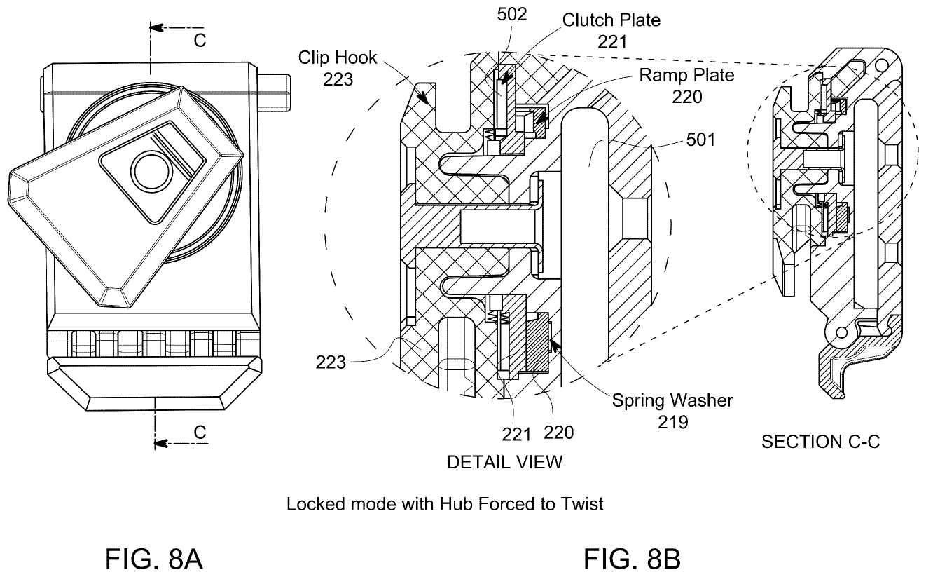

FIG. 8A shows an example lock mode of the rotary clip of FIG. 1. More specifically, FIG. 8A shows rotary clip 105 with clip hook 223, button second end 208b, and section C-C.

The lock button 208 is in its right-most position placing the rotary clip 105 in locked mode. The cross-section C-C is described further below with respect to FIG. 8B.

FIG. 8B shows an example lock mode forced rotation cross-section C-C of the rotary clip of FIG. 1. More specifically, FIG. 8B shows a passageway 501 between the clip rear shell 201 and clip front shell 202, hub 218, spring washer 219, ramp plate 220, clutch plate 221, clip rivet 226, clip hook 223, and shell latch 229.

In various embodiments, when the rotary clip 105 is in locked mode, as signified by the lock button 208 being in its right-most position and the first button end 208b being visible, the clutch partial inner rims 230a and 230b and clutch partial outer rims 231a and 231b are not in contact with and are disengaged from the corresponding hook plate partial inner rims 252a and 252b, and hook plate partial outer rims 253a and 253b. This arrangement eliminates the air gap 502 between these plates and prevents the clip hook 223 from rotating freely because the clutch symmetrical sawtooth elements 302 come in contact with and engage the symmetrical sawtooth elements on the hook plate 227. At this point, if a sufficiently large force is applied to the clip hook 223 to overcome the locking force holding clip hook 223 in a predetermined lock position, the clutch partial inner rims 230a and 230b and clutch partial outer rims 231a and 231b come into contact with and engage corresponding hook plate partial inner rims 252a and 252b, and hook plate partial outer rims 253a and 253b. In this configuration, the spring washer 219 is pressed flat into a 2D disk, and clip hook 223 can rotate out of the predetermined lock position. At this point, if the clip hook 223 is manually turned, it will again enter a normally locked state when it reaches a predetermined lock position.

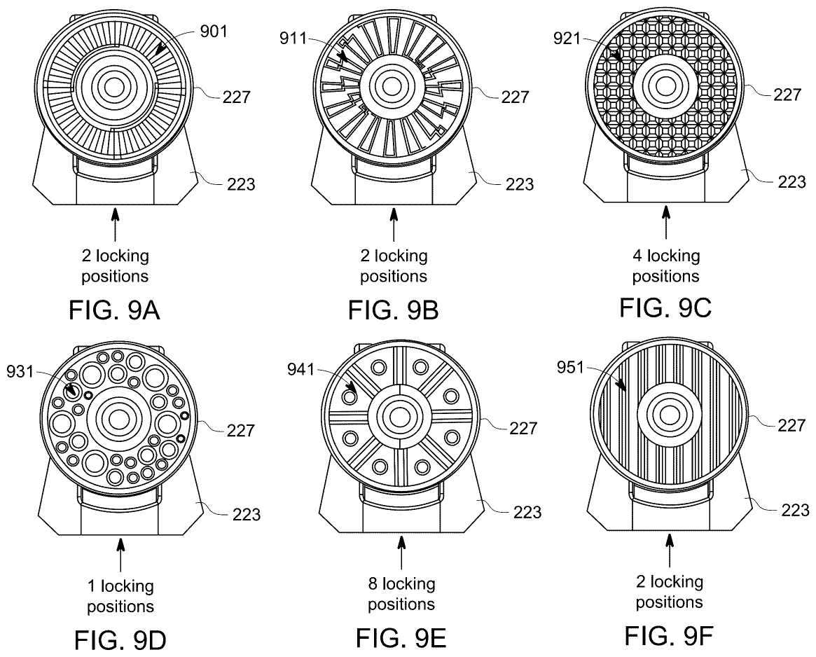

FIG. 9A shows a first example configuration of the front side of the hook plate of the rotary clip of FIG. 1. More specifically, FIG. 9A shows clip hook 223, hook plate 227, and a ripple pattern 901.

In various embodiment, hook plate 227 may have the ripple pattern 901 as shown. A complementary ripple pattern is provided on the clutch plate front surface 221a that engages with hook plate 227 to lock the clip hook 223 (and integrated hook plate 227) in a lock position. Ripple pattern 901 provides two lock positions.

FIG. 9B shows a second example configuration of the front side of the hook plate of the rotary clip of FIG. 1. More specifically, FIG. 9A shows clip hook 223, hook plate 227, and a ripple pattern 911.

In various embodiment, hook plate 227 may have the ripple pattern 911 as shown. A complementary ripple pattern is provided on the clutch plate front surface 221a that engages with hook plate 227 to lock the clip hook 223 (and integrated hook plate 227) in a lock position. Ripple pattern 911 provides two lock positions.

FIG. 9C shows a third example configuration of the front side of the hook plate of the rotary clip of FIG. 1. More specifically, FIG. 9A shows clip hook 223, hook plate 227, and a ripple pattern 921.

In various embodiment, hook plate 227 may have the ripple pattern 921 as shown. A complementary ripple pattern is provided on the clutch plate front surface 221a that engages with hook plate 227 to lock the clip hook 223 (and integrated hook plate 227) in a lock position. Ripple pattern 921 provides two lock positions.

FIG. 9D shows a fourth example configuration of the front side of the hook plate of the rotary clip of FIG. 1. More specifically, FIG. 9A shows clip hook 223, hook plate 227, and a ripple pattern 931.

In various embodiment, hook plate 227 may have the ripple pattern 931 as shown. A complementary ripple pattern is provided on the clutch plate front surface 221a that engages with hook plate 227 to lock the clip hook 223 (and integrated hook plate 227) in a lock position. Ripple pattern 931 provides one lock position.

FIG. 9E shows a fifth example configuration of the front side of the hook plate of the rotary clip of FIG. 1. More specifically, FIG. 9A shows clip hook 223, hook plate 227, and a ripple pattern 941.

In various embodiment, hook plate 227 may have the ripple pattern 941 as shown. A complementary ripple pattern is provided on the clutch plate front surface 221a that engages with hook plate 227 to lock the clip hook 223 (and integrated hook plate 227) in a lock position. Ripple pattern 941 provides eight lock positions.

FIG. 9F shows a sixth example configuration of the front side of the hook plate of the rotary clip of FIG. 1. More specifically, FIG. 9A shows clip hook 223, hook plate 227, and a ripple pattern 951.

In various embodiment, hook plate 227 may have the ripple pattern 951 as shown. A complementary ripple pattern is provided on the clutch plate front surface 221a that engages with hook plate 227 to lock the clip hook 223 (and integrated hook plate 227) in a lock position. Ripple pattern 951 provides eight lock positions.

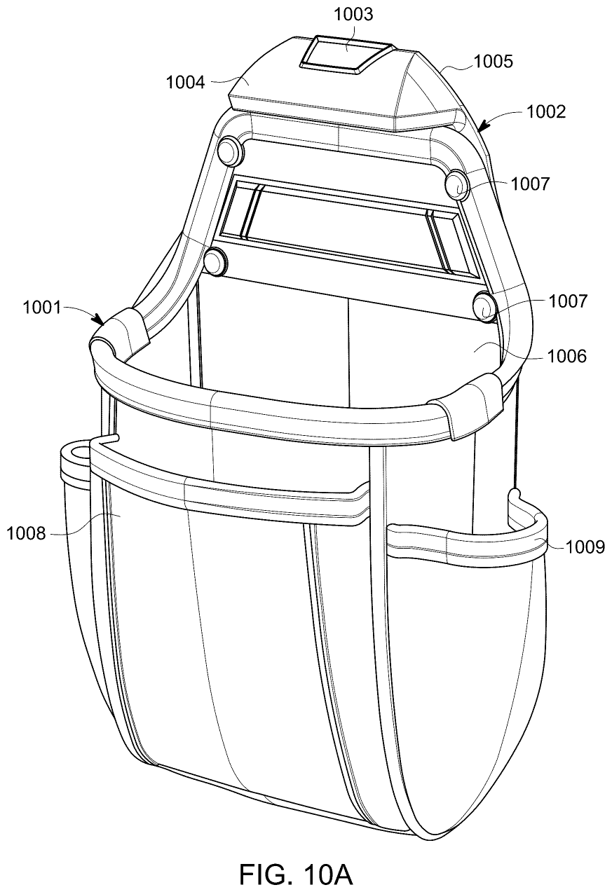

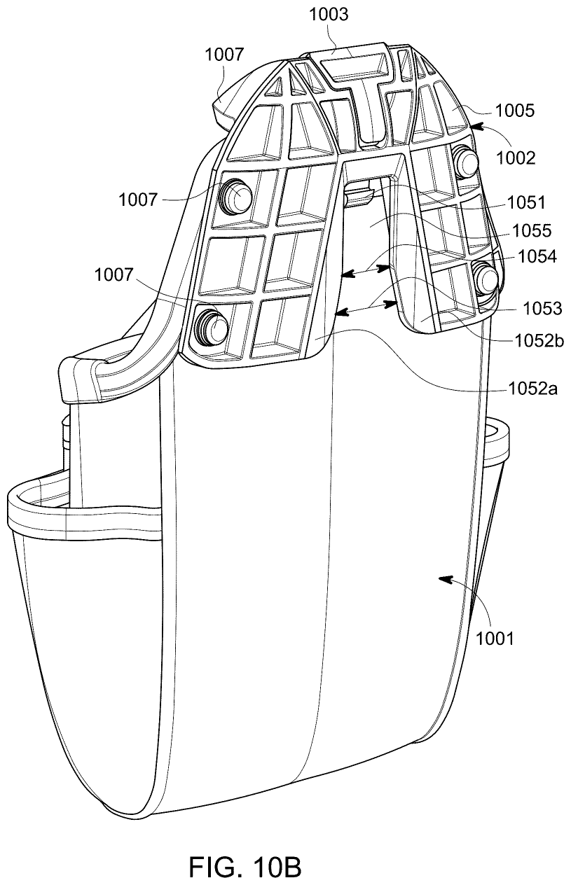

FIG. 10A shows an example front view of a pouch and clip assembly. More specifically, FIG. 10A shows a pouch 1001, a pouch clip adapter 1002, a pouch release button 1003, a pouch handle 1004, a clip adapter body 1005, a main compartment 1006, clip adapter fasteners 1007, a front pocket 1008, and a side pocket 1009.

In various embodiments, the pouch 1001 may be a tool pouch to hold various tools, such as screw drivers, hammers, tape measures, and the like, or parts and components, such as nails, nuts, rivets, screws, cable ties, and the like. These tools and components may be distributed in the various pockets and compartments of the pouch 1001 such as the main compartment 1006, the front pocket 1008, and the side pocket 1009. When the pouch1001 is attached to a rotary clip 105 that is mounted on a toolbelt or a toolbox or other support surfaces and members that may move around and change angle with respect to the gravitational horizon or the gravitational vertical. Under such conditions, if the pouch 1001 is not held approximately at an upright or vertical orientation, the contents of the pouch 1001, whether tools or parts, may spill out. For example, if a worker wearing a toolbelt with pouch hanging from the toolbelt climbs a ladder at a non-zero angle from the vertical orientation, some of the contents of the pouch may fall out. If the rotary clip 105 is placed in an unlocked mode of operation, the pouch 1001 weight will cause the pouch 1001 to take a vertical orientation, thus preventing the spillage of its contents. Under different circumstances, when the worker wearing the toolbelt is moving around in an industrial shop or on a construction site, the heavy pouch 1001 may swing back and forth causing instability or discomfort if not locked in place. To avoid such swinging, the rotary clip 105 may be placed in the locked mode to prevent movement of the pouch 1001 attached to the rotary clip 105.

In various embodiments, pouch 1001 may be attached to a pouch clip adapter 1002 to enable the pouch 1001 to be attached to the rotary clip 105. Pouch 1001 may be attached to the rotary clip 105 via an adapter hook (described later) and released via the pouch release button 1003.

In various embodiments, pouch 1001 includes a pouch handle 1004 that may in the form of an overhang with a hollow space below (similar to a cap) it that fits over one or more fingers. Pouch 1001 may be released from the rotary clip 105 using the pouch release button 1003, all with one hand. For example, several fingers may be used to grab the pouch handle 1004 while pressing the pouch release button 1003 with the thumb, thereby releasing the pouch 1001 from the rotary clip 105 and removing the pouch 1001.

In various embodiments, the clip adapter fasteners 1007 may be rivets, bolts and nuts, or other similar fasteners to attach the pouch 1001 to the pouch clip adapter 1002. The attachment of the pouch 1001 to the pouch clip adapter 1002 may be permanent or user-removable.

In various embodiments, the clip adapter body 1005 may be made of a rigid or semi-rigid material such as plastic, fiberglass, aluminum, and the like to rigidly hold the pouch 1001 under its control. In some embodiments, the clip adapter body may have a honey-comb-like structure to reduce weight and increase stiffness. This way, the pouch 1001 follows the motions and positions taken by the clip adapter body 1005. For example, if the clip adapter body is tilted to one side, the pouch 1001 is tilted to same extent in the same direction. Those skilled in the art will appreciate that a rigid body is one that does not deform under normal operating conditions and handling and returns to its original shape if slightly and temporarily deformed under excessive forces such as heavy loads or pressure.

FIG. 10B shows an example rear view of the pouch and clip assembly of FIG. 10A. More specifically, FIG. 10B shows pouch 1001, pouch clip adapter 1002, pouch release button 1003, pouch handle 1004, clip adapter body 1005, fasteners 1007, an adapter hook 1051, adapter flaps or flanges 1052a and 1052b, a wide slot opening 1053, a narrow slot channel 1054, and an adapter slot 1055.

In various embodiments, the adapter hook 1051 is used to securely attach the pouch clip adapter 1002 to the clip hook 223 via a recess (described later) on the clip hook 223. The pouch release button 1003 is an integral part of and is one piece with the adapter hook 1051. Pressing the pouch release button 1003 lifts up or pushes back the adapter hook 1051 to detach it from the clip hook 223.

In various embodiments, the slot 1055 is formed by the two adapter flanges 1052a and 1052b on the sides of adapter slot 1055. At the top of the adapter slot 1055 adapter hook 1051 is deployed to engage with the recess within the clip hook 223. Adapter slot 1055 has a funnel shape with a wide slot opening 1053 and a narrow slot channel 1054. The narrow slot channel 1054 has a smaller width than the wide slot opening 1053, as shown. Slot 1055 fits over and encloses clip hook 223, which includes a hook narrow end 224 and a hook broad end 225. Adapter slot 1055 slides over clip hook 223 like a sliding drawer. The hook narrow end 224 enters the wide slot opening 1053 and continues upwards to enter the narrow slot channel 1054 until it is locked in by adapter hook 1051. At this point the hook broad end 225 is enclosed by the wide slot opening 1053 and the pouch 1001 is fully attached to the rotary clip 105 via clip hook 223. The funnel shape of the adapter slot 1055 and its wide slot opening 1053 make it easier to find and enclose the hook narrow end 224 and start the sliding process of the adapter slot 1055 onto clip hook 223.

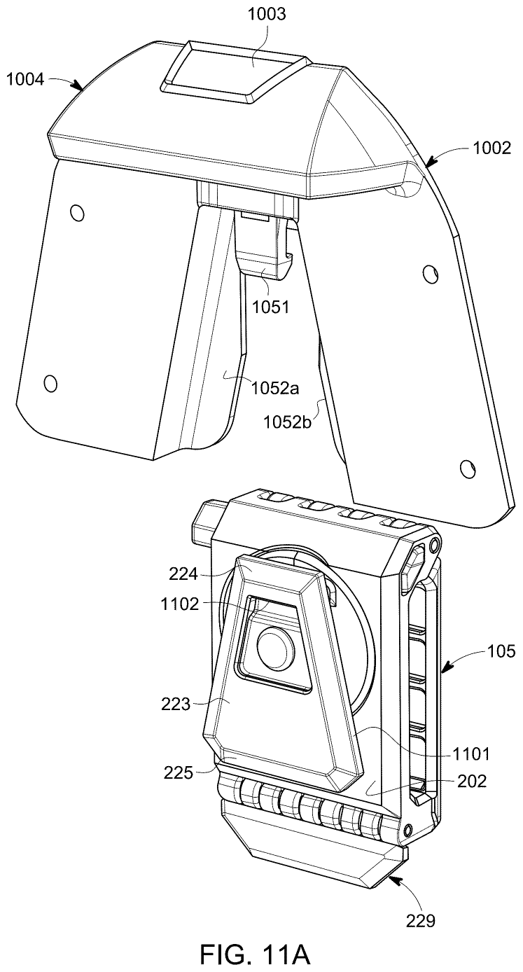

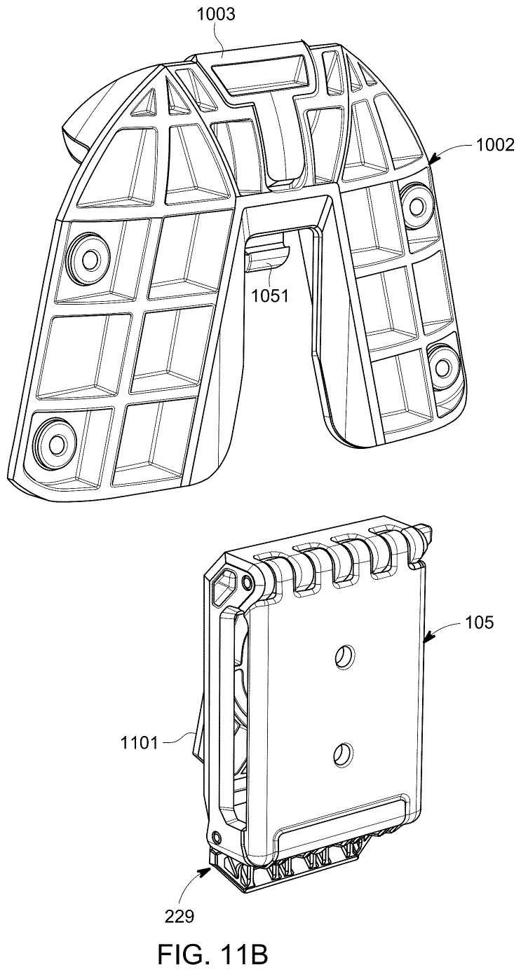

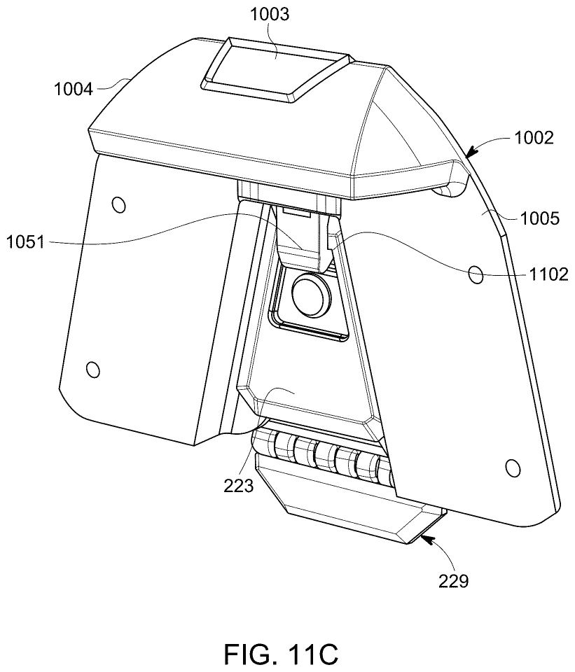

FIG. 11A shows an example exploded front view of a pouch clip adapter. More specifically, FIG. 11A shows pouch clip adapter 1002 having pouch release button 1003, pouch handle 1004, adapter hook 1051, adapter flanges 1052a and 1052b. It further shows rotary clip 105 with clip front shell 202, clip hook 223, hook narrow end 224, hook broad end 225, shell latch 229, hook edge 1101, and a clip hook recess 1102.

In various embodiments, the pouch adapter 1002 is positioned above the hook clip 223, as defined by positioning the wide slot opening 1053 next to or over the hook narrow end 224 to allow a downward sliding motion of the pouch clip adapter 1002 onto full engagement with the clip hook 223. The adapter flanges 1052a and 1052b fit between shallow channels created between the clip hook 223 and clip front shell 202 along hook edge 1101 all around the perimeter of clip hook 223. The channels formed this way guide the adapter flanges 1052a and 1052b down the length of clip hook 223 from the hook narrow end224 towards hook broad end 225. The sliding of clip hook 223 into the adapter slot 1055 continues until the adapter hook 1051 clips onto the clip hook recess 1102 below the hook narrow end 224. At this point the pouch clip adapter 1002 and the pouch 1001 are firmly attached to the rotary clip 105.

In various embodiments, the pouch adapter 1002 includes a hook receptacle for receiving the clip hook 223. The hook receptacle is formed by the pouch release button 1003, adapter hook 1051, the adapter flanges 1052a and 1052b, and the adapter slot 1055. These components together form the hook receptacle as an assembly. The hook receptacle assembly is designed to couple with and lock onto the clip hook 223. Accessories other than the pouch 1001, such as various tools, lamps, magnifying glass, and the like include a similar receptacle to couple with clip hook 223. Some accessories like the pouch may be used with the rotary clip 105 when mounted on a toolbelt, while other accessories like a work light may be used with the rotary clip 105 when mounted on a support surface like a toolbox or a wall.

In various embodiments, once the pouch 1001 is attached to clip hook 223, the pouch 1001 follows the motions and behavior of clip hook 223. More specifically, when clip hook 223 is in locked mode, the pouch 1001 is also locked in the same position and orientation as the clip hook 223. When clip hook 223 is in unlocked mode and can rotate freely, the pouch 1001 can also rotate freely.

In various embodiments, the pouch 1001 may include a pouch locking mechanism deployed within the pouch clip adapter 1002 to control the motion and behavior of the pouch. For example, a rotary lock may be deployed on the adapter hook 1051 that prevents the adapter hook 1051 and the attached pouch 1001 from rotating or swinging about the mounting apparatus, such as a clip attached to a toolbelt. A release on the pouch locking mechanism may free the pouch 1001 to rotate freely about the mounting point. The behavior of the pouch under its own pouch locking mechanism is substantially similar to the behavior of pouch mounted on the rotary clip 105 as controlled by the locking mechanism of rotary clip 105 and clip hook 223, as described herein. More specifically, in some embodiments, the pouch 1001 can be locked in a lock position using the pouch locking mechanism and can also be released to rotate, and in some other embodiments, the pouch 1001 is mounted on the rotary clip and its position and behavior is controlled by the locking mechanism on the rotary clip 105 and its operating modes of Locked and unlocked set by using the clip lock button 208.

FIG. 11B shows an example exploded rear view of a pouch clip adapter. More specifically, FIG. 11B shows the rear side of pouch clip adapter 1002 having pouch release button 1003, and adapter hook 1051. It further shows rotary clip 105 with shell latch 229, and hook edge 1101.

In various embodiments, the pouch adapter 1002 is positioned above the hook clip 223, as defined by positioning the wide slot opening 1053 next to or over the hook narrow end 224 to allow a downward sliding motion of the pouch clip adapter 1002 onto full engagement with the clip hook 223, as described above with respect to FIG. 11A.

FIG. 11C shows an example a pouch clip adapter coupled with a rotary clip. More specifically, FIG. 11C shows clip hook 223, shell latch 229, pouch clip adapter 1002, pouch handle 1004, clip adapter body 1005, pouch release button 1003, adapter hook 1051, and clip hook recess 1102.

In various embodiments, to unhook and remove the pouch 1001 from the rotary clip 105, the user may place several fingers under the pouch handle 1004 and press the pouch release button 1003 with another finger or thumb to push the adapter hook 1051 off of the clip hook recess 1102 and pull up and remove the pouch 1001.

It will be understood that unless explicitly stated or specified, the steps described in a process are not ordered and may not necessarily be performed or occur in the order described or depicted. For example, a step A in a process described prior to a step B in the same process, may actually be performed after step B. In other words, a collection of steps in a process for achieving an end-result may occur in any order unless otherwise stated.

Changes can be made to the claimed invention in light of the above Detailed Description. While the above description details certain embodiments of the invention and describes the best mode contemplated, no matter how detailed the above appears in text, the claimed invention can be practiced in many ways. Details of the system may vary considerably in its implementation details, while still being encompassed by the claimed invention disclosed herein.

Particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the claimed invention to the specific embodiments disclosed in the specification, unless the above Detailed Description section explicitly defines such terms. Accordingly, the actual scope of the claimed invention encompasses not only the disclosed embodiments, but also all equivalent ways of practicing or implementing the claimed invention.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” It is further understood that any phrase of the form “A/B” shall mean any one of “A”, “B”, “A or B”, or “A and B”. This construct includes the phrase “and/or” itself.

The above specification, examples, and data provide a complete description of the manufacture and use of the claimed invention. Since many embodiments of the claimed invention can be made without departing from the spirit and scope of the disclosure, the invention resides in the claims hereinafter appended. It is further understood that this disclosure is not limited to the disclosed embodiments, but is intended to cover various arrangements included within the spirit and scope of the broadest interpretation so as to encompass all such modifications and equivalent arrangements.

What is claimed is:

1. A pouch comprising:
a hook receptacle assembly to attach the pouch onto a mounting apparatus, wherein
a locking mechanism locks the pouch to prevent the pouch from rotating and unlocks the pouch to allow the pouch to rotate more than 30 degrees from a gravitational vertical orientation.

2. The pouch of claim 1, wherein the mounting apparatus comprises a rotary clip.

3. The pouch of claim 2, wherein the locking mechanism is deployed on the rotary clip

4. The pouch of claim 3, further comprising a shell latch to lock a front shell and a rear shell of the rotary clip together.

5. The pouch of claim 3, wherein the rotary clip has a narrow end and a broad end.

6. The pouch of claim 3, wherein the locking mechanism includes a rack and pinion mechanism.

7. The pouch of claim 3, wherein the rotary clip includes two modes of operation including a locked mode and an unlocked mode.

8. The pouch of claim 3, wherein the rotary clip hook is locked when in one or more predetermined lock positions.

9. A pouch and clip assembly comprising:
a pouch; and
a pouch adapter coupled with the pouch; wherein
the pouch adapter includes a hook receptacle to mount onto a hook, and wherein
the pouch is rotatable more than 30 degrees and is lockable in a lock position.

10. The pouch and clip assembly of claim 9, further comprising hook plate coupled with the clip hook.

11. The pouch and clip assembly of claim 10, further comprising a clutch plate coupled with the hook plate.

12. The pouch and clip assembly of claim 11, wherein the lock button engages a ramp plate to lock the clip hook.

13. The pouch and clip assembly of claim 12, wherein the clutch plate is constrained to move along a longitudinal axis of the fastener.

14. The pouch and clip assembly of claim 12, wherein the ramp plate is caused to turn clockwise or counterclockwise by a sliding movement of the lock button.

15. A method of hanging objects, the method comprising:
receiving a clip hook of a rotary clip onto an object;
locking the object in a predetermined lock position; and
unlocking the object to rotate more than 30 degrees.

16. The method of claim 15, further comprising locking a shell latch to create a passageway to install the rotary clip on a support member.

17. The method of claim 15, wherein the locking the object comprises sliding a lock button on the rotary clip in a lock direction.

18. The method of claim 15, wherein the predetermined lock position is one of several lock positions.

19. The method of claim 15, wherein the rotary clip has two modes of operation including a locked mode and unlocked mode.

20. The method of claim 19, wherein the rotary clip enters the unlocked mode from the locked mode under sufficient force without changing the mode of operation.
